(19) United States
(12) Patent Application Publication
(10) Pub. No.: US 2023/0108070 A1
(43) Pub. Date: Apr. 6, 2023

(54) BUBBLE COVER TO REDUCE NOISE AND VIBRATION

(71) Applicant: GM GLOBAL TECHNOLOGY OPERATIONS LLC, Detroit, MI (US)

(72) Inventors: Anil K. SACHDEV, Rochester Hills, MI (US); Song HE, Troy, MI (US); Arianna T. MORALES, Bloomfield Hills, MI (US)

(73) Assignee: GM GLOBAL TECHNOLOGY OPERATIONS LLC, Detroit, MI (US)

(21) Appl. No.: 17/492,445

(22) Filed: Oct. 1, 2021

(51) Int. Cl. B21D 26/057; B21D 53/88

(52) U.S. Cl. CPC B21D 26/057; B21D 53/88

(57) ABSTRACT

A cover for integrated power electronics (IPE), the cover including a first sheet, a second sheet bonded to the first sheet by at least one joining point in a perimeter region, a cavity defined between the bonded first sheet and second sheet, wherein the perimeter region seals the cavity, and a filler material disposed within the cavity.

### INTRODUCTION

The present disclosure relates to a tailored bubble cover assembly and method of producing a tailored bubble cover assembly.

Drive units for battery electrical automobiles and other engine driven components may use integrated power electronics (IPE). In conjunction with an electric motor and gears may be transmitted to the IPE that produces undesirable noise. This noise may be partially transmitted by a radiative cover of the IPE. A reduced noise may improve passenger experience.

Machine components are often comprised of panel assemblies. In some industries, panel assemblies may be generally square or uniform in shape, whereas in other industries specific tailored shapes are desired for a panel assembly. In an automotive example, vehicle panel assemblies may include automotive features, such as a cover for an IPE, an inner panel for a door or a deck lid, a dash panel, a glove box door panel, front-of-trunk panel, and other interior panels. To reduce the mass of the panel assemblies, a lighter density material may be used, or the cross sectional thickness of the panel assemblies may be reduced. Reducing the mass of the panel assemblies may facilitate reducing the overall weight of the machine as a whole. A reduction in the weight of a vehicle, for example, may provide increased efficiency that can be used beneficially in various ways. For example, the speed of the vehicle may be increased with the same power expenditure, or the power may be reduced for the same speed. Additionally, a reduced weight may increase the range of an electronic vehicle, which may also be translated into cost savings on the battery pack of an electronic vehicle. Light weight metal panel with reduced thickness may have reduced stiffness and damping, and therefore may be an effective conduit for noise sources. However, panel assembly fabrication may be subject to structural requirements, such as sound-damping and vibration-damping, strength, and/or stiffness requirements, based on overall machine requirements or feature requirements.

### SUMMARY

This section provides a general summary of the disclosure, and is not a comprehensive disclosure of its full scope or all of its features.

The present disclosure relates to bubble covers reducing noise and vibration. The present disclosure related to general purpose panel covers including bubbles as described herein.

In certain aspects, the present disclosure relates to a cover for integrated power electronics (WE), the cover including a first sheet, a second sheet bonded to the first sheet by at least one joining point in a perimeter region, a cavity defined between the bonded first sheet and second sheet, wherein the perimeter region seals the cavity, and a filler material disposed within the cavity.

In one aspect, the filler material is a noise dampening material.

In one aspect, the at least one joining point defines a pattern.

In one aspect, the pattern increases a stiffness of the cover.

In one aspect, each of the first sheet and the second sheet includes a material independently selected from the group including an aluminum alloy, a magnesium alloy, a steel alloy, a titanium alloy, and combinations thereof.

In one aspect, wherein the cover is planar and defines a longitudinal axis, and the cavity extends in only a single direction from the longitudinal axis of the cover.

In one aspect, the cavity extends towards an upper surface of the cover.

In one aspect, the cover faces a passenger area of an automobile, and the IPE is coupled to an engine of the automobile.

In certain aspects, the present disclosure relates to a cover assembly including a first sheet, a second sheet bonded to the first sheet by a plurality of bonds disposed in at least a portion of a perimeter region, a cavity formed within the perimeter region, and a filler material disposed within the cavity, wherein the filler material is a noise dampening material.

In one aspect, the first and second sheets are joined and sealed together at the plurality of bonds including the perimeter region.

In one aspect, the perimeter region forms a hermetic seal.

In one aspect, the plurality of bonds within the perimeter region define a pattern.

In one aspect, the pattern increases a stiffness of the cover.

In one aspect, each of the first sheet and the second sheet includes a material independently selected from the group including an aluminum alloy, a magnesium alloy, a steel alloy, a titanium alloy, and combinations thereof.

In one aspect, the cover is planar and defined a longitudinal axis, and the cavity extends in only a single direction from a longitudinal axis of the cover.

In one aspect, the cavity extends towards an upper surface of the cover.

In certain aspects, the present disclosure relates to a method of forming a cover for integrated power electronics (IPE), the method including forming at least one of a first sheet and a second sheet to have an irregular surface, joining the first and second sheets with a plurality of bonds, the irregular surface forming raised portions having cavities defined between the first and second sheets, filling the cavities with a filler material, and sealing the cavities with the first and second sheets.

In one aspect, the method further including applying a pressurized fluid to the cavities, the pressurized fluid expands, clears, or a combination thereof the cavities.

In one aspect, the forming the plurality of bonds includes using one or more of brazing, welding, laser welding, friction welding, stamping, thermal bonding, or diffusion bonding.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows an exemplary schematic of a cover having a bubble cavity in accordance with certain aspects of the present disclosure.

FIG. 2 shows an exemplary schematic of a cover having a bubble cavity in accordance with certain aspects of the present disclosure.

FIGS. 3A and 3B are illustrative schematic sectional views of a portion of a laminated cover assembly shown in FIG. 2.

FIG. 4 is an illustrative schematic perspective view of the example IPE assembly with a cover.

FIGS. 5A and 5B show a comparison of an example cover (FIG. 5A) and a tailored bubble cover (FIG. 5B) in accordance with certain aspects of the present disclosure.

FIG. 6 shows a comparison of common mode vibrations between the example cover and the tailored bubble cover in accordance with certain aspects of the present disclosure.

FIG. 7 shows a comparison of the decibel (dB) levels between the example cover and the tailored bubble cover in accordance with certain aspects of the present disclosure.

FIG. 8 shows aspects of a method for making a tailored cover assembly according with certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Referring to the figures, example embodiments of the disclosure provide a tailored cover (panel, sheet, or other feature) configured for a reduction in mass. The tailored cover may provide sound-damping and vibration-damping capabilities and/or bending stiffness equivalent to or better than might be attained with a monolithic sheet. As described herein, the tailored cover may be fabricated from a laminated sheet material that includes a desired weld pattern defining various open and closed perimeter regions between a first sheet material and a second sheet material. In some example embodiments, the open perimeter regions may be referred to as bubbles, and the laminated sheet material may be referred to as a bubble sheet. In some example embodiments, the open perimeter region may be specifically designed to provide a structural load path between a first location on the cover and a second location on the cover. The total thickness of the laminate sheet materials may be less than the thickness of the monolithic sheet. Furthermore, the open perimeter regions defined in the cover may be expanded, for example, by fluid pressure (e.g., air pressure) to provide geometric stiffness to the cover. The closed perimeter regions, however, may not be expanded, and may be trimmed, punched, bent, or may define locations utilized for bonding to adjacent structures.

The non-gaseous filler material may be introduced into the expanded regions formed in the cover, or the non-gaseous filler material may be used to form and fill the expanded regions. The non-gaseous filler material may include, but is not limited to, a sound deadening material (e.g., a material which adsorbs vibrations such that ambient noise is reduced), a stiffness controlling material, or a strength controlling material, all of which are described in greater detail below. The introduction of the sound-deadening material may facilitate an increased reduction in noise transmitted through the cover as compared to a monolithic cover.

For example, one technique in automotive environments for minimizing noise, or acoustic vibrations, which may be transmitted to the interior of a passenger cabin of a vehicle, is to provide covers with features that damp the acoustic vibrations that may otherwise reach the passenger cabin. These features may facilitate absorbing and/or dissipating vibrational energy. There are many features that may affect the acoustic properties of the sound-damped covers, including, without limitation, the cover's mass, composition, stiffness, structural damping, and thickness. In some example embodiments, while reducing the mass of a cover may reduce sound-damping and vibration-damping characteristics of the cover, introducing a sound-deadening material to the cover, for example, within the body of the cover, may mitigate any effect on sound transmission due to the reduced mass. Thus, the covers with internal sound-damping and vibration-damping may be optimized for gross geometry to provide the specified level of sound-damping and vibration-damping, strength, and/or stiffness while reducing the overall mass of the covers.

The components formed in accordance with certain aspects of the present disclosure are particularly suitable for use in various components of an automobile or other vehicles (e.g., motorcycles, boats, tractors, buses, motorcycles, mobile homes, campers, and tanks), but they may also be used in a variety of other industries and applications, including aerospace components, consumer goods, devices, buildings (e.g., houses, offices, sheds, warehouses), office equipment and furniture, and industrial equipment machinery, agricultural or farm equipment, or heavy machinery, by way of non-limiting example. Non-limiting examples of automotive components include covers (e.g., IPE covers), panels, including structural panels, door panels, and door components, interior floors, floor pans, roofs, exterior surfaces, underbody shields, bumpers, structural rails and frames, cross car beams, undercarriage or drive train components, and the like.

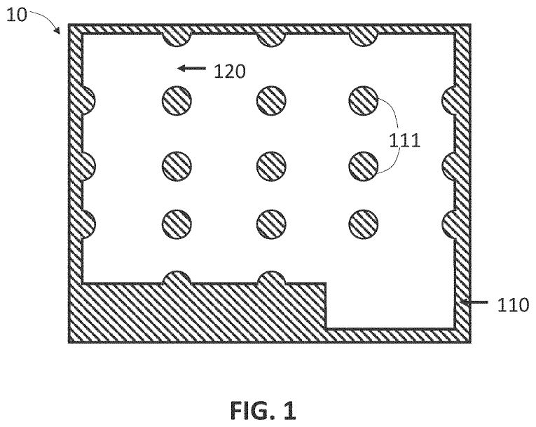

By way of non-limiting example, the methods of the present disclosure pertain to certain radiative covers of IPEs. In certain aspects, such radiative covers have a bubble cavity to enhance damping performance. For example, as shown in FIG. 1, a radiative cover 10 includes a joined area 110 around a bubble cavity 120, including a number of joined areas 111 within the bubble cavity 120. The joined areas 111 may have a regular pattern, as in FIG. 1, or may have an irregular pattern. The bubble cavity 120 may be filled with a non-gaseous filler material, gaseous filler material, or the like.

In some example embodiments, there may be one or more bubble cavities 120 in a cover 10. In some example embodiments, the single or plural bubble cavities 120 may include one or more different materials within the bubble cavities 120. For example, a single bubble cavity 120 may have one, two, three or more different filler materials. For example, one bubble cavity 120 in a cover 10 may have one filler material, and a second bubble cavity 120 may have a different filler material. The bubble cavities 120 may be formed by die casting the cover components prior to joining, casting the cover components prior to joining, by exerting fluid pressure, or the like.

The filler material within the bubble cavity 120 may be protected from an outside environment. For example, the filler material may be sealed, (e.g., hermetically sealed) within the bubble cavity 120 such that the filler material is protected from oxidation, sunlight, and other degradation effects. By sealing the filler material, a wide variety of damping materials may be used. For example, damping materials that would deteriorate if exposed to ambient environments (e.g., sunlight, oxygen, water, salt, and the like) may be used in the sealed environment of the bubble cavity 120.

The bubble cavity 120 may expand in one direction from the cover 10 (e.g., the bubble cavity 120 may expand outward from one side of the cover 10 and the reverse of the cover 10 may be flat or substantially flat), or expand in two directions (e.g., the bubble cavity 120 may expand outward from both sides of the cover 10). In some example embodiments, the bubble cavity 120 is on a side of the cover 10 facing away from the interior of the IPE, for example extending in only a single direction from a longitudinal axis of the cover 10. In some example embodiments, the bubble cavity is on a side of the cover 10 facing towards from the interior of the IPE, for example extending in only one direction from a longitudinal axis of the cover 10. In some example embodiments, the bubble cavity 120 is on both sides of the cover 10.

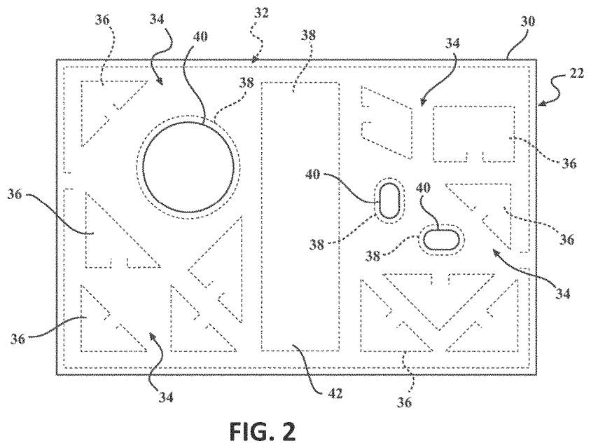

As shown in FIG. 2, a cover 30 has an example bond pattern, illustrating features. In some example embodiments, a cover 30 may have an example bond pattern 32 (dashed lines). In some example embodiments the bond pattern 32 may be formed by laser welding (e.g., a continuous laser weld or a series of laser welds), brazing, welding, friction welding, stamping, thermal bonding, diffusion bonding, or the like. Laser welding, as described herein, is the joining of facing surfaces of the sheet materials by applying laser energy to the sheet materials so that the adjoining surfaces are merged into each other. In some example embodiments, the depth of the weld may be controlled so that at any one bond the weld does not penetrate the distant face of the adjoining sheet. In some example embodiments, the depth of the weld may be controlled to enable full penetration, such as to trim cover openings in one example.

In some example embodiments, the bond pattern 32 may form a pattern of the passageways 34 defined by open perimeter regions 36 and closed perimeter regions 38. The passageways 34 and the open perimeter regions 36 may be expanded to have a cavity, i.e., the sheet materials of the cover 30 may be expanded in an opposing direction, for example, by being die cast with a desired profile. For example, one of the sheet materials of the cover 30 may be cast (or, alternatively, die cast) with a desired profile and joined to another one of the sheet materials of the cover 30 that is planar or substantially planar, such that the open perimeter regions 36 and/or passageways 34 may extend in one direction from a central longitudinal axis of the cover 30. In some example embodiments, one of the sheet materials of the cover 30 may be cast with a first profile, and joined to another one of the sheet materials of the cover 30 that has been cast with a second profile, the second profile may be the same or different from the first profile. The open perimeter regions 36 and/or the passageways 34 may be shaped, sized and/or configured to improve at least one of stiffness, noise dampening, and mechanical strength of the cover. However, the design of the open perimeter regions 36 and/or passageways 34 is not limited thereto, and maybe used, for example, for aesthetic designs, or flow of filler material to promote maximum or desired density.

In some example embodiments, the closed perimeter regions 38, however, are configured to create sealed areas within the closed perimeter regions 38. In some example embodiments, the sealed areas within the closed perimeter regions 38 may be punched, pierced, or cut to create holes 40 through the preform 30. Alternatively, or in addition to, the sealed areas within the closed perimeter regions 38 may define areas 42 for bends or for bonding/connecting to adjacent structures. The openings defining the open perimeter regions 36, especially at an edge of the preform 30, may be used as injection and/or extraction/venting locations of the pressurized fluid.

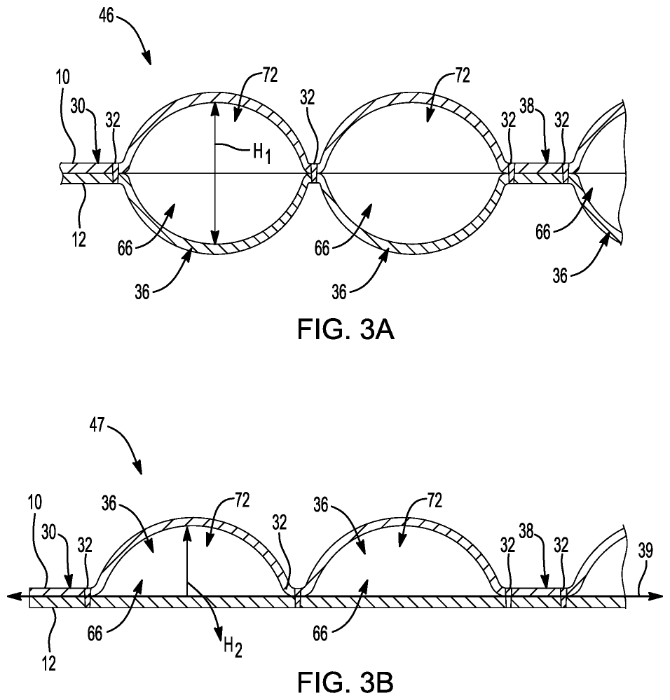

In some example embodiments, the bond pattern 32 is tailored to the particular cover being formed and that any combination of the passageways 34, the open perimeter regions 36, and the closed perimeter regions 38 may be used to meet specific requirements for the particular cover being formed. For example, without limitation, the bond pattern 32 may define one or more isolated regions in the preform 30. In one example, a tailored cover 46 (shown in FIG. 3A), may require stiffness in one portion of the cover, and stiffness with sound damping in another portion of the cover. The bond pattern 32 may define two isolated regions with the tailored cover 46 to address the specific design requirements. As an illustrative example, a first isolated region may be tailored to increase stiffness, while a second isolated region is tailored to incorporate sound-dampening material for additional mitigation of sound transmission. In some example embodiments, the shape of the first isolated region may form into, for example, letters, geometric shapes, designs (e.g., a company logo), patterns or the like.

FIG. 3A is an illustrative sectional view of a portion of a tailored cover 46. As shown, the cavities 72 may be formed between bonds of the bond pattern 32. The bonds facilitate constraining the cavities 72 to the defined open perimeter regions 36. As shown in FIG. 3A, the closed perimeter region 38 is not expanded due to the closed perimeter bond of the bond pattern 32 preventing the fluid or other material from entering the closed perimeter region. The cavities 72 have a height H1.

In some example embodiments, the perimeter shape of the open perimeter regions 36 may be any desired shape and size that enables the tailored cover 46 to function as described herein. Furthermore, the expanded shape of the cavities 72 may generally be non-uniform because of the different sizes and shapes of the preselected bond pattern 32. In some example embodiments, the cavities 72 will be expanded in a generally spherical shape. In some example embodiments, the cavities 72 may take on a desired shape, such as being expanded entirely or substantially from one side of the tailored cover 46. In some example embodiments, the cavities 72 are filled with a gas, such as argon, nitrogen, compressed air, or other suitable gasses. The gases may be injected under high pressure to facilitate forming the cavities 72; however, the gases may also be injected under low pressure. In some example embodiments, the cavities 72 may be filled with a non-gaseous filler material, such as but not limited to an insulating material, a sound deadening (e.g., noise dampening) material, a stiffness controlling material, a strength controlling material, or the like. The insulating and/or sound-deadening material may include for example, without limitation, various polymers, polymer composites, plastisols, syntactic sound attenuating materials (i.e., materials containing microspheres), and the like. In some example embodiments, the sound-deadening material may be a material that expands based on a chemical reaction in the sound-deadening material. For example, without limitation, the chemical reaction may have a delay before causing the sound-deadening material to expand, or require an additional process, such as heating, to activate the reaction causing the sound-deadening material to expand. In such embodiments, the sound-deadening material may be introduced into the cavities 72 after the cavities are formed. In some example embodiments, a heat-insulting material may be introduced into cavities 72 such that the tailored panel assembly 46 provides thermal insulation. The interior 66 is defined by the open perimeter regions 36 formed in the laminated sheet material 22, or preform 30.

In some example embodiments, the tailored cover 46 may be formed from aluminum, magnesium, titanium, stainless steel, alloys thereof, polymer composites, carbon fiber composites, or the like.

In some example embodiments, the tailored cover 46 may include a first sheet 10 and second sheet 12. In some example embodiments, the first sheet 10 and second sheet 12 may include aluminum, magnesium, titanium, stainless steel, alloys thereof, polymer composites, carbon fiber composites, or the like. In some example embodiments, one or both of the first sheet 10 and second sheet 12 may be die cast to form the cavities 72. In some example embodiments, one or both of the first sheet 10 and second sheet 12 may be stamped, undergo superplastic forming, or the like to include the cavities 72.

In some example embodiments, the filler material is injected into the cavities 72. In some example embodiments, the filler material is a sheet of filler material aligning with the cavities 72 of the tailored cover 46, which may be placed before joining the first sheet 10 and second sheet 12.

FIG. 3B is an illustrative sectional view of a portion of a tailored cover 47. In some example embodiments, the cavities 72 may be formed between bonds of the bond pattern 32, with the interior 66 extending in only one direction from a longitudinal axis 39 of the tailored cover 47 having a height H2 in only one direction from the longitudinal axis 39. The bonds facilitate constraining the cavities 72 to the defined open perimeter regions 36.

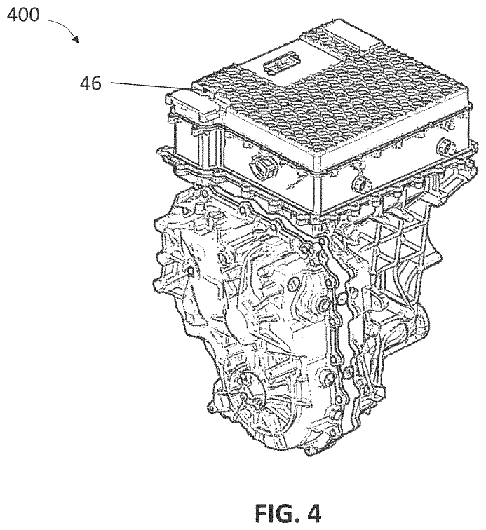

Referring to FIG. 4, an IPE and engine assembly 400 is embodied as an engine compartment for a vehicle. The IPE and engine assembly 400 may have a tailored cover 46 including a bond pattern with multiple open perimeter regions 36 (not shown).

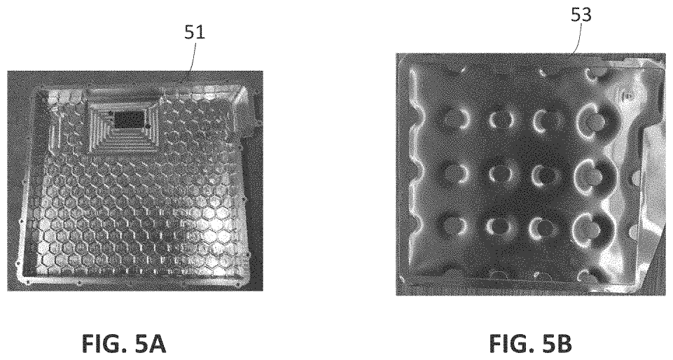

Referring to FIGS. 5A and 5B, an example cover 51 with ribs for noise reduction (FIG. 5A) is compared to an example embodiment tailored bubble cover 53 (FIG. 5B). The example cover 51 is an IPE cover that is 6061 Aluminum alloy at about or exactly 3 mm. The example cover 51 has honeycombed ribbing patterns. The tailored bubble cover 53 is an IPE cover that is 6061 Aluminum alloy with a bottom plate about or exactly 3 mm thick, and an upper plate about or exactly 0.5 mm thick. The example cover 51 has a mass of 1.59 kilograms (kg). The tailored bubble cover 53 has a mass of 1.17 kg. The tailored bubble cover 53 further includes air cavities, or bubbles, between the bottom and upper plates. In this example, the tailored bubble cover 53 may have a 26% mass reduction to the example cover 51 with removal of the ribs of the example cover 51 while maintaining stiffness.

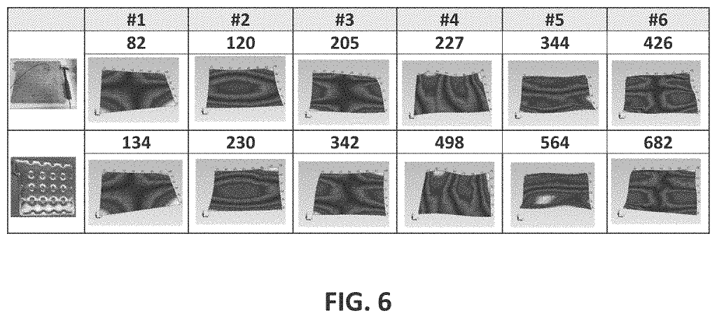

Referring to FIG. 6, a comparison is shown of the natural frequencies of the example cover 51 and the tailored bubble cover 53. FIG. 6 shows a first to sixth common mode of vibration between the example cover 51 and the tailored bubble cover 53, and the associated natural frequency in Hz. A natural frequency is the frequency or rate that an object vibrates naturally when disturbed. A common mode may be a shared mode shape of the example cover 51 and the tailored bubble cover 53, in which the deformation that the component would show when vibrating at the natural frequency.

At a first common mode, the example cover 51 may have a natural frequency of 82 Hz and the tailored bubble cover 53 may have a natural frequency of 134 Hz. At a second common mode, the example cover 51 may have a natural frequency of 120 Hz and the tailored bubble cover 53 may have a natural frequency of 230 Hz. At a third common mode, the example cover 51 may have a natural frequency of 205 Hz and the tailored bubble cover 53 may have a natural frequency of 342 Hz. At a fourth common mode, the example cover 51 may have a natural frequency of 227 Hz and the tailored bubble cover 53 may have a natural frequency of 498 Hz. At a fifth common mode, the example cover 51 may have a natural frequency of 344 Hz and the tailored bubble cover 53 may have a natural frequency of 564 Hz. At a sixth common mode, the example cover 51 may have a natural frequency of 426 Hz and the tailored bubble cover 53 may have a natural frequency of 682 Hz.

In other words, the tailored bubble cover 53 may have a natural frequency about 1.75 times greater than the example cover 51 at a common mode. A higher natural frequency may reduce vibration and thus noise. The tailored bubble cover 53 having higher natural frequencies improves noise dampening. In some example embodiments, a tailored bubble cover having a bubble cavity may increase the natural frequency at a common node compared to a cover without a bubble cavity.

These frequencies are illustrative of an example cover and an example embodiment of the inventive concepts, and the natural frequencies may vary with different designs, and may be modified as desired. For example, the panel size, geometry of the panel and bubble cavity 120, thicknesses may alter the common modes.

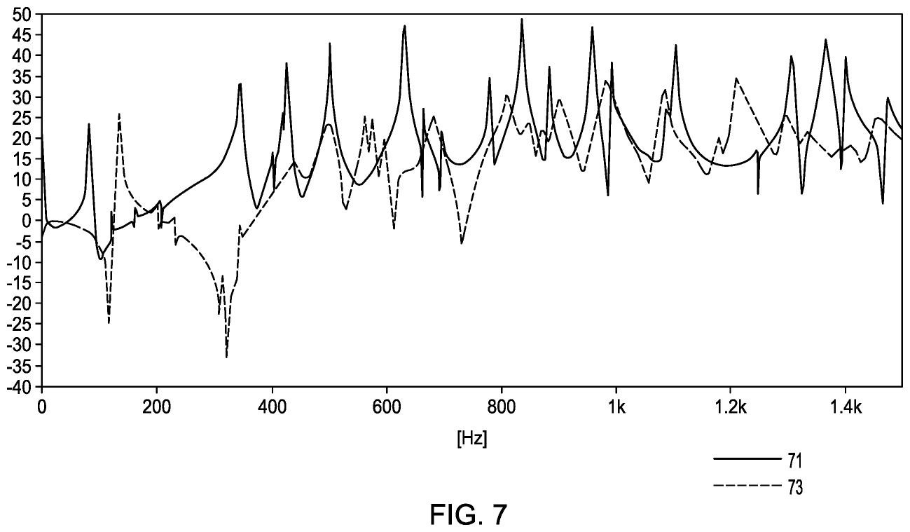

Referring to FIG. 7, a comparison of the decibel (dB) levels of the example cover 51 and the tailored bubble cover 53 at different Hz levels is shown. The line 71 shows the Hz levels of the example cover 51, and the line 73 shows the Hz levels of the tailored bubble cover 53. As illustrated, the tailored bubble cover 53 shows a 10+dB reduction at cover resonances. The higher natural frequency of the tailored bubble cover 53 shifts the dB peaks to higher frequencies. Additional filler material may reduce the dB levels. In some example embodiments, having the bubble cavity 120 facing out of the IPE and engine assembly 400 may further reduce the dB levels. The tailored bubble cover 53 does not include damping material. In some example embodiments, including a filler material (e.g., a damping material) in the bubble cavity 120 of the tailored bubble cover 53 may further reduce the dB levels transmitted through/by the tailored bubble cover 53.

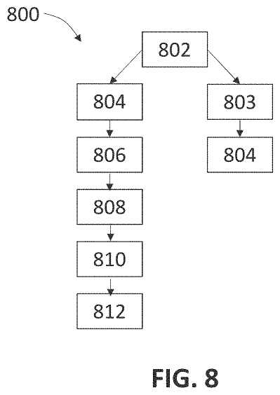

FIG. 8 is a flow chart illustrating some example embodiment operations of fabricating a tailored panel assembly 46. The method 800 is described herein with respect to fabricating a preform and the tailored panel assembly 46 (or, for example, the cover 10) shown in FIGS. 1-3. In operation 802, at least one of the first and second sheets 10 and 12 may be die cast to form an irregular surface. The irregular surface may be the basis of forming the cavities 72. For example, the irregular surface may include raised portions that when joined to another sheet form the cavities 72. In some example embodiments, only the first sheet 10 is die cast to form an irregular surface. In some example embodiments, only the second sheet 12 is die cast to form an irregular surface. In some example embodiments, both the first sheet 10 and second sheet 12 are die cast to form an irregular surface. In some example embodiments, one or both of the first sheet 10 and second sheet 12 may instead be stamped, undergo superplastic forming, or the like to include the cavities 72.

A plurality of bonds may be formed at operation 804 between the first sheet 10 and the second sheet 12. This facilitates bonding the sheet materials of the first and second sheets 10, 12 in a face-to-face relationship to form a preform. In some example embodiments, the preform may contain the cavities 72. The plurality of bonds define the closed perimeter regions 38 and the open perimeter regions 36 between the sheet materials 10, 12. The preform may be formed at operation 806 into the desired shape of the tailored cover 46. A pressurized fluid (not shown) may be applied at operation 808 through the inlet to the preform. The inlet is coupled in fluid communication with the open perimeter regions 36 between the sheets 34 of the preform 30 to expand the preform 30. The pressurized fluid expands the open perimeter regions 36 between the sheet materials 10, 12 such that the sheet materials 10, 12 expand in an opposing direction, thereby defining the cavities 72. The closed perimeter regions 38 defined between the sheets remain vacant of the pressurized fluid such that the closed perimeter regions 38 are not expanded. In some example embodiments, operation 808 is not performed, for example, due to the cavities 72 being present due to die-casting without the need to expand. In some example embodiments, operation 808 is performed with a pressurized fluid to clear the cavities 72 without expanding or substantially expanding the cavities 72. The cavities 72 are filled at operation 810 with a non-gaseous filler material (not shown). At operation 812, any remaining openings to the cavities 72 are sealed by joining the first and second sheet 10, 12.

In some example embodiments, an operation 803 may be performed if a sheet of filler material is used. The operation 803 includes placing the sheet of filler between the first and second sheets 10, 12 before forming the plurality of bonds in operation 804.

The exemplary operations presented in FIG. 8 are not intended to provide any limitations on the order or manner of steps or operations implemented in the cover fabrication process. Any number of suitable alternatives may be performed during the cover fabrication process to facilitate increasing the cover's sound-deadening, stiffness, and strength characteristics. For example, the first and second sheets 10, 12 may be cold worked in a rolling mill, annealed, and formed in a forming toll or die.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A cover for integrated power electronics (IPE), the cover comprising:
a first sheet;
a second sheet bonded to the first sheet by at least one joining point in a perimeter region;
a cavity defined between the bonded first sheet and second sheet, wherein the perimeter region seals the cavity; and
a filler material disposed within the cavity,
a first side of the cover is planar and defines a longitudinal axis, and
the cavity extends in only a single direction from the longitudinal axis of the cover, the cavity extending towards an upper surface of the cover and away from a noise source, such that the first side faces the noise source, the noise source being inside of an assembly the cover is configured to close over.

2. The cover of claim 1, wherein the filler material is a noise dampening material.

3. The cover of claim 1, wherein the at least one joining point defines a pattern.

4. The cover of claim 3, wherein the pattern increases a stiffness of the cover.

5. The cover of claim 1, wherein each of the first sheet and the second sheet comprises a material independently selected from the group consisting of: an aluminum alloy, a magnesium alloy, a steel alloy, a titanium alloy, and combinations thereof.

6. (canceled)

7. (canceled)

8. The cover of claim 1, wherein
the cover faces a passenger area of an automobile, and
the IPE is coupled to an engine of the automobile.

9. An integrated power electronics (IPE) and engine assembly comprising:
an engine;
a compartment housing an IPE, the housing including a cover, the cover including
a first sheet;
a second sheet bonded to the first sheet by a plurality of bonds disposed in at least a portion of a perimeter region;
a cavity formed within the perimeter region; and
a filler material disposed within the cavity, wherein the filler material is a noise dampening material,
a first side of the cover is planar and defines a longitudinal axis, and
the cavity extends in only a single direction from the longitudinal axis of the cover, the cavity extending towards an upper surface of the cover and away from the IPE, such that the first side faces the IPE.

10. The IPE and engine assembly of claim 9, wherein the first and second sheets are joined and sealed together at the plurality of bonds including the perimeter region.

11. The IPE and engine assembly of claim 10, wherein the perimeter region forms a hermetic seal.

12. The IPE and engine assembly of claim 9, wherein the plurality of bonds within the perimeter region define a pattern.

13. The IPE and engine assembly of claim 12, wherein the pattern increases a stiffness of the cover.

14. The IPE and engine assembly of claim 9, wherein each of the first sheet and the second sheet comprises a material independently selected from the group consisting of: an aluminum alloy, a magnesium alloy, a steel alloy, a titanium alloy, and combinations thereof.

15. (canceled)

16. (canceled)

17. A method of forming a cover for integrated power electronics (IPE), the method comprising:
forming at least one of a first sheet and a second sheet to have an irregular surface;
joining the first and second sheets with a plurality of bonds, the irregular surface forming raised portions having cavities defined between the first and second sheets;
filling the cavities with a filler material; and
sealing the cavities with the first and second sheets,
a first side of the cover is planar and defines a longitudinal axis, and
the cavity extends in only a single direction from the longitudinal axis of the cover, the cavity extending towards an upper surface of the cover and away from a noise source, such that the first side faces the noise source.

18. The method of claim 17, further comprising:
applying a pressurized fluid to the cavities, the pressurized fluid expands, clears, or a combination thereof the cavities.

19. The method of claim 17, wherein the forming the plurality of bonds includes using one or more of brazing, welding, laser welding, friction welding, stamping, thermal bonding, or diffusion bonding.
